(19) United States
(12) Patent Application Publication
(10) Pub. No.: US 2026/0317912 A1
(43) Pub. Date: Oct. 15, 2026

(54) METHOD AND DEVICE FOR INTEGRATING HEAT INTO A DISTRICT HEATING NETWORK

(71) Applicant: Siemens Energy Global GmbH & Co. KG, Munich, Bayern (DE)

(72) Inventors: Torsten Jambor, Dusseldorf (DE); Thomas Neuenhahn, Düsseldorf (DE); Christian Hüttl, Forchheim (DE)

(73) Assignee: Siemens Energy Global GmbH & Co. KG, Munich, Bayern (DE)

(21) Appl. No.: 19/108,623

(22) PCT Filed: Aug. 24, 2023
(86) PCT No.: PCT/EP2023/073280

§ 371 Date: Mar. 4, 2025

(30) Foreign Application Priority Data
Sep. 15, 2022 (DE) 10 2022 209 704.1

(51) Int. Cl. C25B 1/04; F24D 10/00

(52) U.S. Cl. CPC C25B 1/04; F24D 10/003; F24D 2200/12; F24D 2200/16

(57) ABSTRACT

An energy system and a method for operating an energy system, which includes a hydrogen production unit having at least one electrolyzer for water electrolysis, the electrolyzer being thermally coupled to a cooling water circuit; and a heat pump, the heat source side of which is thermally coupled to the cooling water circuit and the heat sink side of which is coupled via a heat exchanger to a district heat or useful heat circuit. A heat store is incorporated into the district heat or useful heat circuit, the return line of which is connected downstream of the heat exchanger and the feed line of which is connected upstream of the heat exchanger of the heat pump, such that heat from the heat store is used to raise the return temperature of the district heat or useful heat circuit.

### CROSS REFERENCE TO RELATED APPLICATIONS

This application is the US National Stage of International Application No. PCT/EP2023/073280 filed 24 Aug. 2023, and claims the benefit thereof, which is incorporated by reference herein in its entirety. The International Application claims the benefit of German Application No. DE 10 2022 209 704.1 filed 15 Sep. 2022.

### FIELD OF INVENTION

The invention relates to a device and a method for integrating heat into a district heating network.

The invention is concerned with the production of hydrogen and the poor coefficient of performance of hydrogen electrolysis and the heat produced thereby.

### BACKGROUND OF INVENTION

It is to be expected that the CO₂-neutral and timely supply of heating networks such as district heating and industrial processes will be increasingly based on heat pumps. In order to achieve a high coefficient of performance (COP), heat pumps require a waste heat source with a constant heat flow as the input heat flow.

The waste heat that accumulates during hydrogen production may be used as the input heat flow. Typically, the generation of hydrogen takes place via electrolysis, for example via proton exchange electrolysis or membrane electrolysis. The electrolysis here takes place at temperatures in the range of 30 degrees Celsius to 80 degrees Celsius, with approximately 50 percent to 80 percent of the electric energy used being converted into hydrogen. The heat released during the electrical separation of hydrogen and oxygen from water must be cooled down. Waste heat is likewise produced during the subsequent compression of the hydrogen to the required operating pressure. The coefficient of performance of the hydrogen generation process as a whole is therefore below 50 percent. The majority of the energy used is therefore converted into heat.

DE 10 2019 202 439 A1 already describes an energy system having an electrolyzer for water electrolysis and a heat pump with which the waste heat from the electrolyzer may be increased and provided for a heating network.

However, multiple problems arise when using waste heat from hydrogen production with a heat pump: on the one hand, the electrolyzer ages, which means that the coefficient of performance drops over time and, with this, the waste heat generated increases. For an electrolyzer with 17 MW of electrical power, the waste heat would increase over time from 5 MW to 8.5 MW. Consequently, a relatively small heat pump is sufficient for a new electrolyzer, whereas a relatively large heat pump will be required for an aged electrolyzer. Furthermore, cost effective operation for hydrogen production is driven by the energy price. This requires a flexible operation mode of the electrolyzer along with continuous delivery of hydrogen, oxygen and heat, which requires a complex control procedure and operation mode of the various components (electrolyzer, heat pump, heat reservoir, compressor for oxygen and hydrogen). Furthermore, the problem arises that, with the coupling of the electrolyzer and the heat pump, two components with different operating behaviors and ramp-up curves come together. An electrolyzer, as a chemical-electrical process, reacts more rapidly to control interventions, whereas a heat pump together with a compressor react more slowly to control interventions due to the inertia thereof with a rotating mass. If the individual components are not used according to their start-up and shut-down curves, this may result in a total failure of the system or the dynamic operation mode may not be realized. The dynamic operation mode must take into account fluctuations in energy prices for operating the systems and fluctuations in the removal of hydrogen, oxygen and heat.

### SUMMARY OF INVENTION

The present invention is based on an object of improving the utilization of heat from water electrolysis as a heat source for a heat pump and eliminating the said problems.

The object is achieved by a device and a method having the features of the independent claims. Advantageous configurations and developments of the invention are specified in the dependent claims.

The device according to the invention relates to an energy system, comprising a hydrogen production unit having at least one electrolyzer for water electrolysis, which electrolyzer is thermally coupled to a cooling water circuit, a heat pump, whereof the heat source side is thermally coupled to the cooling water circuit and whereof the heat sink side is coupled to a district or utility heating circuit via a heat exchanger. According to the invention, a heat reservoir is incorporated into the district or utility heating circuit, the return line of which heat reservoir is connected downstream of the heat exchanger and the feed line of which heat reservoir is connected upstream of the heat exchanger of the heat pump so that the return line temperature of the district or utility heating circuit can be raised using heat from the heat reservoir.

The method according to the invention relates to the operation of an energy system, wherein hydrogen is produced through water electrolysis by means of an electrolyzer, the heat that accumulates during the hydrogen production is transferred to the heat source side of a heat pump, the temperature level is raised via the heat pump and it is discharged into a district or utility heating circuit. According to the invention, a heat reservoir is incorporated into the district or utility heating circuit, the return line of which heat reservoir is connected downstream of the heat exchanger and the feed line of which heat reservoir is connected upstream of the heat exchanger of the heat pump so that the return line temperature of the district or utility heating circuit is raised using heat from the heat reservoir.

The invention firstly starts with the consideration that, due to the low energy efficiency or due to the high quantity of thermal energy that accumulates on the one hand and the high temperatures of approximately 40 °C on the other, hydrogen electrolysis is advantageously suitable for providing this thermal energy in district heating networks or for utilizing it for industrial processes. For the Carnot coefficient of performance of a heating network with a feed temperature of 110 °C, the increase in the COP of the heat pump for the waste heat of the electrolysis at 40 °C compared to that of otherwise normal river water at 10 °C is 5.5 for the waste heat of the electrolyzer and 3.8 for waste heat from river water. The waste heat of the hydrogen production unit may be raised to the temperature level of a district or utility heating circuit via the heat pump and therefore made useful.

The invention moreover recognizes that it is necessary to adapt the fluctuating quantities of thermal energy generated to the continual demand of the heat pump so that the heat pump may be operated under full load and therefore with an optimal coefficient of performance. This adaptation is surprisingly achieved using a heat exchanger whereof the return line is connected downstream of the heat reservoir and whereof the feed line is connected upstream of the heat exchanger of the heat pump.

Due to the arrangement of the heat reservoir, it is possible to compensate both slowly changing heat quantities, such as are caused by the aging of the electrolyzer, and rapidly changing heat quantities, such as are caused by the differing operating behavior and ramp-up curves of the electrolyzer and heat pump. Due to the heat exchanger according to the invention, the hydrogen production unit is directly cooled on the one hand and the heat production is uncoupled from the heat utilization. The heat pump may thus be overdimensioned for the waste heat that accumulates due to the hydrogen production unit, so that the heat pump has sufficient reserves if the waste heat increases due to aging. This compensation may take place via a control procedure which, in the event of increasing waste heat on the heat source side of the heat pump, reduces the proportional heat flow output from the heat reservoir into the district or utility heating circuit accordingly, so that the heat pump may continue to be operated under full load.

Due to the invention, the waste heat utilization from the electrolyzer and the other components may be increased from 75% to over 90% energy efficiency. Compared to an arrangement without a heat pump, it is possible to save on additional coolers or other equipment for cooling the electrolyzer.

In addition to the electrolyzer, further components of the hydrogen unit may be incorporated into the cooling water circuit, it being possible to discharge and utilize the waste heat of said further components, for example a hydrogen compressor, an oxygen compressor or other heat sources of the unit.

In order to further increase the flexibility when configuring the heat pump capacity, in an advantageous development of the invention, a cold reservoir is additionally provided, which is incorporated into the cooling water circuit. This cold reservoir is provided in addition to a possibly existing back-up cooler and assists with directly cooling the hydrogen production unit. Due to the cold reservoir, the hydrogen production unit is directly cooled on the one hand and the heat production is uncoupled from the heat pump. The heat pump may thus be underdimensioned for the waste heat that accumulates due to the hydrogen production unit or an age-related increase in waste heat may be compensated.

The cold reservoir here may be part of the control system in which the heat reservoir and cold reservoir are both control variables. Via a corresponding control procedure, if there is a reduced quantity of waste heat on the heat source side of the heat pump, the proportional heat flow output from the cold reservoir to the heat source side of the heat pump may therefore be increased so that the heat pump may continue to be operated under full load.

Depending on the size of the cold reservoir, the waste heat may also result simply from charging the cold reservoir. This may be advantageous, for example, during start-up of the energy system or in the event of a failure of the heat pump. To this end, in an advantageous further development of the invention, the feed line of the cold reservoir is connected to the heat source side of the heat pump so that the cold reservoir can be discharged via the heat pump. This operation mode is advantageous in the event of a failure of the hydrogen production unit, for example, if waste heat no longer accumulates. Due to this further development, a closed circuit may be formed between the cooling water reservoir and the heat pump, which increases the flexibility during the operation of the system.

The invention is preferably suitable for high temperature heat pumps. High temperature heat pumps are notable for achieving high feed temperatures of more than 100 to up to 150 degrees Celsius.

### BRIEF DESCRIPTION OF THE DRAWINGS

The invention and the advantageous further developments are described in more detail below with reference to figures, in which:

FIG. 1 shows the energy system according to the invention with a heat reservoir;

FIG. 2 shows a further development of the energy system according to the invention with a cold reservoir;

FIG. 3 shows a further development with a particular interconnection of the energy system for the discharging of the cold reservoir.

### DETAILED DESCRIPTION OF INVENTION

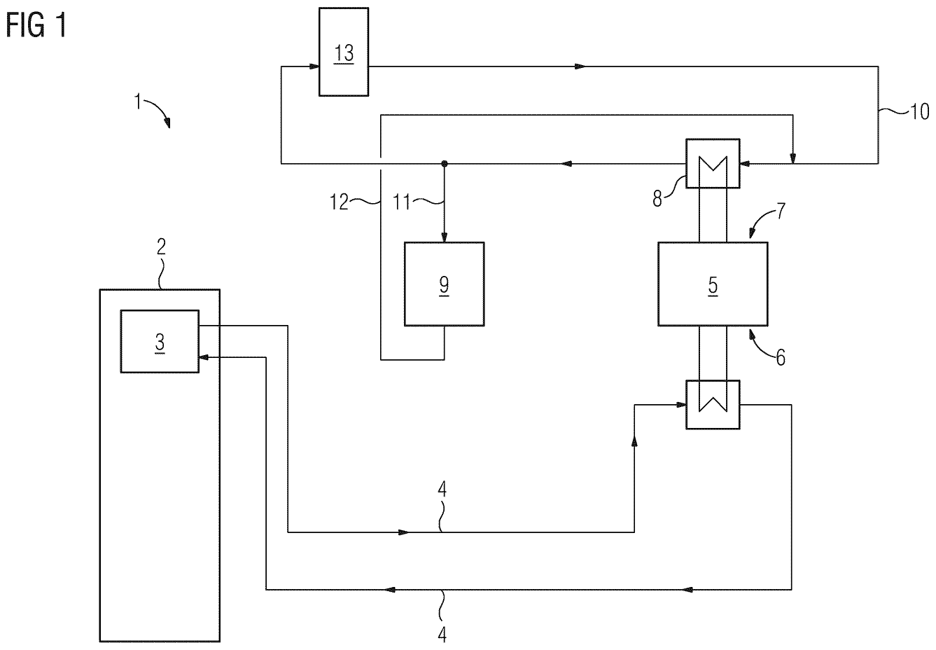

FIG. 1 shows the energy system 1 according to the invention with a heat reservoir 9 having a feed line 12 and a return line 11.

Moreover illustrated is a hydrogen production unit 2, having at least one electrolyzer 3 for water electrolysis, a cooling water circuit 4, a heat pump 5 having a heat source side 6 and a heat sink side 7, a heat exchanger 8 and a district or utility heating circuit 10, which is part of a district heating network.

Hydrogen is produced by the electrolyzer 2 through water electrolysis. In the case of an electrolyzer with 70 MW of power, this may correspond to 15 MW of waste heat. This heat is transferred to the heat source side 7 of the heat pump 5 via a cooling water circuit 4. The heat pump 5 therefore cools the hydrogen production unit 2 directly. The temperature level of the heat is raised via the heat pump 5 and it is discharged into the district or utility heating circuit 10 via a heat exchanger 8. The invention is characterized in that the heat reservoir 9 is incorporated into the district or utility heating circuit 10, the return line 11 of which heat reservoir is connected downstream of the heat exchanger 8 and the feed line 12 of which heat reservoir is connected upstream of the heat exchanger 8 of the heat pump 5. Consequently, the return line temperature of the district or utility heating circuit 10 may be raised using heat from the heat reservoir 9.

In this configuration, upon the start-up of the electrolyzer 3, the heat pump capacity is overdimensioned for the waste heat that accumulates. The heat pump 5 is therefore overdimensioned. The heat pump may nevertheless be operated under full load, and therefore with an optimal coefficient of performance, since the temperature difference is compensated by the heat reservoir 9. The necessary adaption over time to the aging of the electrolyzer 3 is compensated accordingly via a control procedure. During the control procedure, if there is an increasing quantity of waste heat on the heat source side 6 of the heat pump 5, the proportional heat flow output from the heat reservoir 9 into the district or utility heating circuit is reduced accordingly.

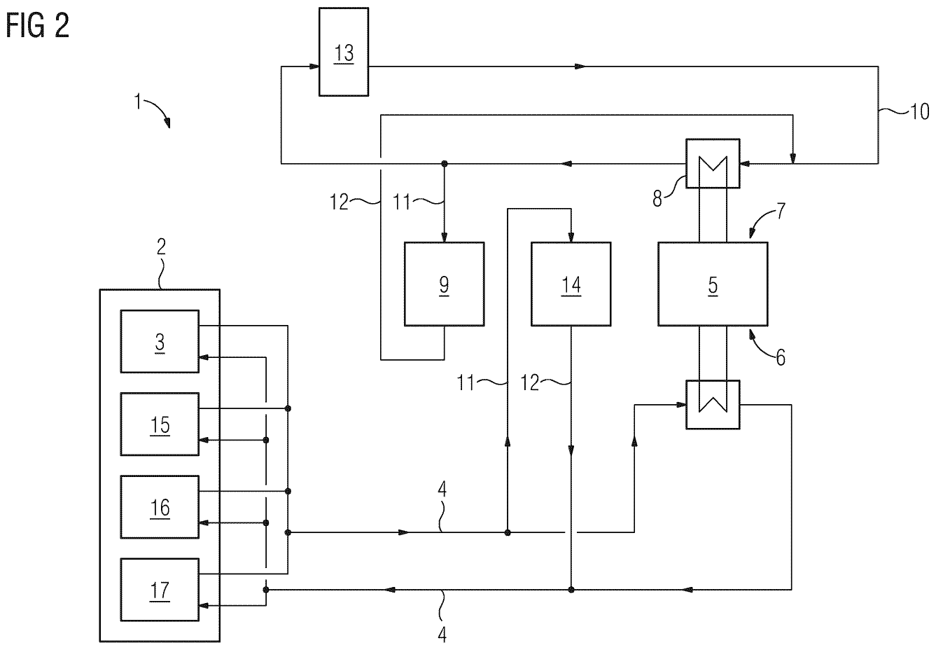

FIG. 2 shows a further development of the invention with an additional cold reservoir 14, which is incorporated into the cooling water circuit. In FIG. 2, it is moreover shown that, in addition to the electrolyzer 3, the hydrogen production unit 2 may comprise further components, for example a hydrogen compressor unit 15, an oxygen compressor unit 16, and other waste heat sources. The cold reservoir 14 is incorporated into the cooling water circuit 4. As a result of the cold reservoir 14, the flexibility when configuring the heat pump capacity may be further increased. As a result of the cold reservoir 14, the hydrogen production unit 2 is directly cooled on the one hand and the heat production may be uncoupled from the heat pump 5.

In this configuration, during start-up of the electrolyzer 3, the heat pump capacity is less than or equal to the waste heat that accumulates. The heat pump 5 is therefore already underdimensioned at the start or after the aging of the electrolyzer 3. The heat pump 5 may thus be relatively small. The heat pump may nevertheless be operated under full load, and therefore with an optimal coefficient of performance, since the temperature difference is compensated by the cold reservoir 14. The necessary adaption over time to the aging of the electrolyzer 3 is controlled accordingly.

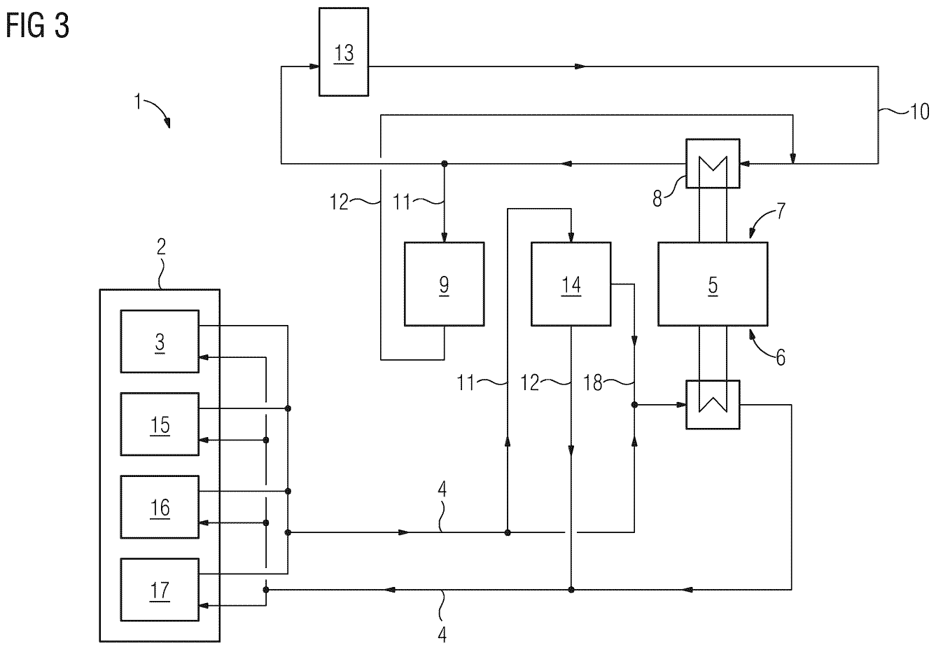

FIG. 3 shows a further development with a particular interconnection of the energy system 1 for the discharging of the cold reservoir 14. The feed line 12 of the cold reservoir 14 is connected to the heat source side 6 of the heat pump 5 via a branch line 18. Consequently, the cold reservoir may be discharged via the heat pump. Due to this further development, a closed circuit may be formed between the cold reservoir 14 and the heat pump 5. This may be advantageous, for example, upon the start-up of the energy system 1 or in the event of a failure of the hydrogen production unit 2.

1. An energy system, comprising
a hydrogen production unit having at least one electrolyzer for water electrolysis, which electrolyzer is thermally coupled to a cooling water circuit,
a heat pump, whereof a heat source side is thermally coupled to the cooling water circuit and whereof a heat sink side is coupled to a district or utility heating circuit via a heat exchanger,
a heat reservoir which is incorporated into the district or utility heating circuit, a return line of which heat reservoir is connected downstream of the heat exchanger and a feed line of which heat reservoir is connected upstream of the heat exchanger of the heat pump so that a return line temperature of the district or utility heating circuit can be raised using heat from the heat reservoir.

2. The energy system as claimed in claim 1, further comprising:
a cold reservoir incorporated into the cooling water circuit.

3. The energy system as claimed in claim 2,
wherein the feed line of the cold reservoir is connected to the heat source side of the heat pump so that the cold reservoir can be discharged via the heat pump.

4. The energy system as claimed in claim 1,
wherein the heat pump is a high temperature heat pump.

5. A method for operating an energy system, comprising:
producing hydrogen through water electrolysis by of an electrolyzer,
transferring heat that accumulates during the hydrogen production to a heat source side of a heat pump via a cooling water circuit,
raising a temperature level via the heat pump and discharging into a district or utility heating circuit via a heat exchanger,
wherein a heat reservoir is incorporated into the district or utility heating circuit, a return line of which heat reservoir is connected downstream of the heat exchanger and a feed line of which heat reservoir is connected upstream of the heat exchanger of the heat pump so that a return line temperature of the district or utility heating circuit is raised using heat from the heat reservoir.

6. The method for operating an energy system as claimed in claim 5, further comprising:
a cold reservoir incorporated into the cooling water circuit.

7. The method for operating an energy system as claimed in claim 6,
wherein the feed line of the cold reservoir is connected to the heat source side of the heat pump so that the cold reservoir may be discharged via the heat pump.

8. The method for operating an energy system as claimed in claim 5,
wherein the heat pump is a high temperature heat pump.
